(19) United States
(12) Patent Application Publication
(10) Pub. No.: US 2012/0319818 A1
(43) Pub. Date: Dec. 20, 2012

(54) Article and Cable Management System Having Article and Cable Monitoring and Locating Capability

(75) Inventors: Neil J. Unger, Newtown, CT (US); William L. DiBella, Arlington, TX (US)

(73) Assignee: CENTRIC SOLUTIONS, LLC, Coppell, TX (US)

(21) Appl. No.: 13/493,035

(22) Filed: Jun. 11, 2012

Related U.S. Application Data
(60) Provisional application No. 61/496,776, filed on Jun. 14, 2011.

(51) Int. Cl. G06K 7/01; G08B 5/22

(52) U.S. Cl. 340/8.1

(57) ABSTRACT

A cable management system is provided having an associational device for providing information that uniquely identifies a cable of a cable-equipped system, the device being operatively coupled to the cable and an assembly for receiving information in a wireless manner from the associational device, the assembly being operable to correlate unique identifying information of the cable with a data element concerning a location. The associational device is a radio frequency identification tag.

### RELATED APPLICATION

This is a U.S. non-provisional application relating to and claiming the benefit of U.S. Provisional Patent Application Ser. No. 61/496,776 filed Jun. 14, 2011.

### BACKGROUND OF THE INVENTION

The present invention relates to a system for monitoring the attributes, position and movement of articles within a building. More particularly, it relates to a cable management system having a cable locating capability and a method for using the cable management system.

Optical and copper cabling used in energy delivery, telecommunications and computer systems have a wide variety of characteristics, capacities and connector types. Additionally, these systems comprise large numbers of cables that may number in the thousands and the cables may be distributed within a building, over a campus network or a wide area network.

One known cable network management system involves manual labeling of cables and written database documents such as logs or computer based cable record keeping databases in the form of spread sheets, wherein time consuming entries must be made in manual fashion in the logs or spread sheets every time a cable is installed or moved. These database approaches are subject to the disadvantage that errors in the manual entries or omissions of manual entries result in increasing variance of the database with the actual situation of the type, number, and location of cables in the telecommunication or computer system and so the database cannot be relied upon with confidence when decisions based upon the information in the database are to be made.

One approach to incorporating an automated feature into a cable management system relies upon detecting or sensing a characteristic of a signal that is transmitted on the cables that are tracked by the cable management system. For example, a characteristic of a signal transmitted on a cable such as an IP address may be relied upon by this automated cable management system to determine whether a cable is attached (i.e., an IP address is sensed or detected) or is not attached (i.e., no IP address is sensed or detected). In the event that no IP address is sensed or detected, this automated cable management system may make a determination that the respective cable for which no IP address could be sensed or detected has a disconnected status. Yet this determination may not reflect the actual status of the respective cable as, for example, a failure to sense or detect the IP address of the respective cable may be attributable to an event other than a disconnection of the cable such as, for example, an event such as a power failure, a router failure, an NIC failure, or a switch failure. Moreover, this automated cable management system lacks a capability to conveniently update information with respect to a location of a cable and, as well, information concerning a signal transmitted on a cable, to the extent such information is archived by this automated cable management system, and is by itself of little use in determining a location of a cable. Additionally, an automated cable management system of this type may lack an enhanced feature that could provide information concerning the physical characteristics of, for example, the type and characteristics of the cable links deployed in the cable system, whereupon the automated cable management system is of little use in determining if the different sections of cable used in a link are compatible with one another. As an example, in a computer network, if an optical cable that has a glass specification for slow speeds is used with high speed transmitters and receivers, the respective associated link may perform a linking function but it may be necessary to downgrade the speed of the transmitters and receivers associated with the linked cables to achieve reliable synchronization. In this case, only a less-than-optimal network performance will be realized while the full potential of relatively expensive high speed interfaces will not be completely exploited.

### OBJECTS OF THE INVENTION

It is one object of the present invention to provide a system for monitoring the position, location and movement of articles, such as cables, within a building.

It is another object of the present invention to provide a new cable management system and method for operating a cable management system that have many of the advantages of the cable management system mentioned heretofore and many novel features that result in a new cable management system or method which is not anticipated, rendered obvious, suggested, or even implied by any of the prior art cable management systems, either alone or in any combination thereof.

It is an object of the present invention to provide a cable management system having an associational device for providing information that uniquely identifies a cable of a cable-equipped system, the device being operatively coupled to the cable and an assembly for receiving information by a wired or wireless manner from the associational device, the assembly being operable to correlate unique identifying information of the cable with a data element concerning a location. The associational device is preferably a radio frequency identification tag.

### SUMMARY OF THE INVENTION

In accordance with one form of this invention, there is provided a system for monitoring the position and movement of articles within a building. A plurality of articles, such as cables, is provided. At least one radio frequency identification (“RF-ID”) tag is associated with each article. The RF-ID tag associated with a particular article contains information which distinguishes that particular article from the other articles. The building receiving at least some of the articles. A plurality of readers are located within the building. The readers are enabled to decipher information from the RF-ID tags. The readers are spaced apart from one another forming a reader grid. A monitoring station is provided. The readers are connected to the monitoring station by a communication channel whereby the position and movement of articles within the building may be determined.

In accordance with another form of this invention, there is provided a system for monitoring the position and movement of articles within a building. A plurality of articles is provided. At least one radio frequency identification (“RF-ID”) tag is associated with each article. The RF-ID tag associated with a particular article contains information which distinguishes that particular article from the other articles. The building receiving at least some of the articles. The building has at least two rooms. A portal located between the two rooms. A data acquisition station is associated with the portal. The data acquisition station including a reader. The reader is enabled to decipher information from the RF-ID tags. A monitoring station is provided. The reader is connected to a monitoring station by a communications channel whereby the movement of articles through the portal may be determined.

In another form of this invention, there is provided a method for determining the location of one end of an installed cable, including providing an elongated cable having first and second ends; applying a first radio frequency identification (“RF-ID”) tag proximate the first end; applying a second RF-ID tag proximate the second end; installing the cable in a building wherein the first end of the cable is at a first location in the building and the second end of the cable is at a second location in the building; inputting information to the first RF-ID tag, including information concerning the fact that the second end of the cable is located at the second location in the building; providing a reader which is enabled to decipher information from the first and second RF-ID tags whereby the location of the second end of the cable may be determined by the reader receiving information from the first RF-ID tag.

In accordance with another form of this invention, there is provided a system for obtaining information about devices attached to an interconnection apparatus. An interconnection apparatus is provided and a plurality of devices are connected to the interconnection apparatus. A child radio frequency (“RF-ID”) tag is connected to each device. Each child RF-ID tag contains information about the device it is connected to. A parent RF-ID tag is attached to the interconnection apparatus. A reader is provided which is enabled to decipher information from the parent RF-ID tag and each child RF-ID tag. The parent RF-ID tag contains at least some information which is contained in each child RF-ID tag whereby certain information about each device may be obtained by using the reader to access information from the parent RF-ID tag.

Aspects of this invention enable the association of the location, article characteristics, article movement, and personnel involved with article movement, as well as the use of alarm signals indicating such movement.

### BRIEF DESCRIPTION OF THE DRAWINGS

FIG. 1 is a perspective view of a building, with the ceiling and roof removed, that houses a telecommunication system and one embodiment of the cable management system of the present invention operable to manage selected tasks in connection with the cables of the telecommunication system.

FIG. 2 is a perspective view of a building, with the ceiling and roof removed, that houses a telecommunication system and one embodiment of the cable management system of the present invention operable to manage selected tasks in connection with the cables of the telecommunication system and showing a cable having one end that has been re-located to a different location in comparison to its location as shown in FIG. 1.

FIG. 3 is a perspective view of a portion of the ceiling and of a wall of the building of FIGS. 1 and 2.

FIG. 4 is an enlarged perspective view of an RF-ID tag of the one embodiment of the cable management system of the present invention operationally coupled to a cable shown in FIG. 1.

FIG. 5 is a schematic view of a reader and monitor of one embodiment of the cable management system of the present invention.

FIG. 6 is a schematic diagram of a reader and its operational relationship to an RF-ID tag of one embodiment of the cable management system of the present invention.

FIG. 7 is a schematic layout of the inside of a building having a plurality of readers arranged in a grid with the ceiling and roof removed for clarity.

FIG. 8 is a perspective view of a portal having a reader over the top of the portal.

FIG. 9 is a perspective view of a portal having readers and other sensing devices located on the sides of the portal.

FIG. 10 shows a cable having RF-ID tags attached to each end.

FIG. 11 shows a connection apparatus, such as a patch panel, having a plurality of cables attached thereto.

### DETAILED DESCRIPTION OF THE PREFERRED EMBODIMENTS

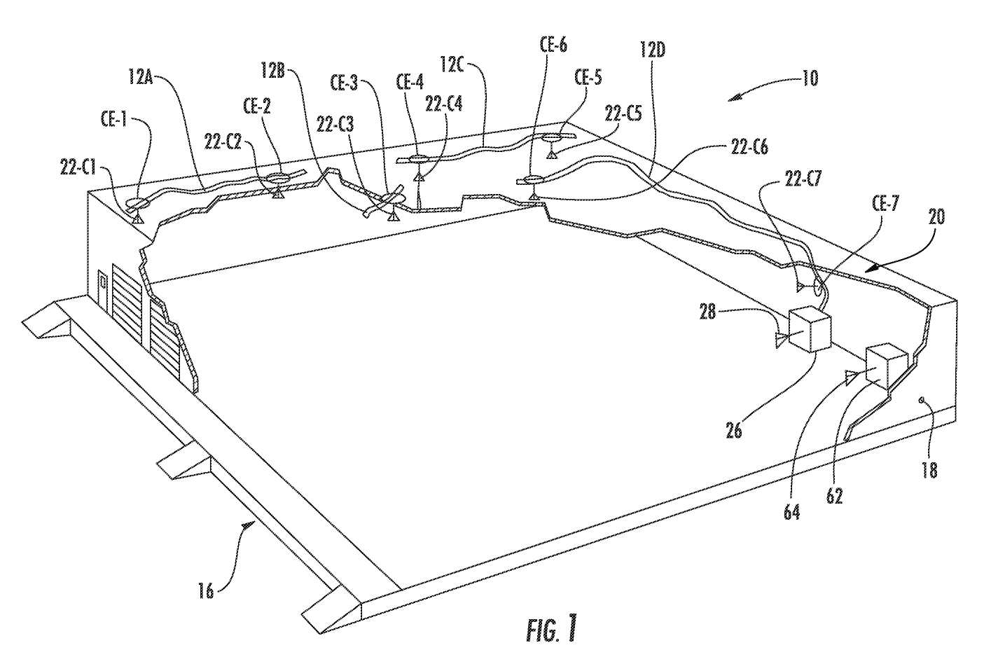

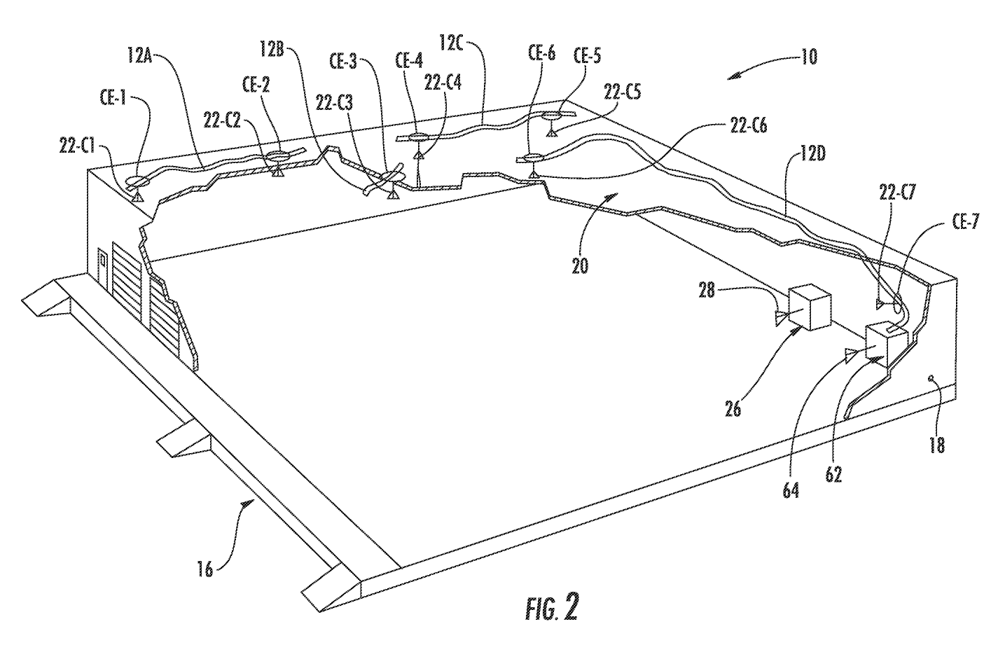

With reference now to FIGS. 1-6, one embodiment of the cable management system of the present invention will now be described. The cable management system 10 is operable to manage selected tasks with respect to a plurality of cables 12A-D, which may be any type of cable operating in any type of cable-equipped system such as, for example, a telecommunication system or a computer system. As used herein, “telecommunication” includes telecommunications, data communications, local area networks, wide area networks, SAN, and NAS. The cables 12A-D are shown solely for the purpose of illustration as being the cables of a telecommunication system 14 that provides a wide area network in a building 16. As seen in FIG. 1, which is a perspective view of the building 16 that houses the telecommunication system 14 and the cable management system 10, each of the cables 12A-D extends between the interior and exterior surfaces of the walls 18 of the building 16 and/or extends between the interior and exterior surfaces of the ceiling 20 of the building 16 in a pathway that is delimited by the respective opposed ends of the cable. Although the cables 12A-D illustrated in FIGS. 1 and 2 therefore extend along a total of four (4) respective pathways, it will be understood that these cables 12A-D representatively illustrate a cable inventory that may number in the thousands of cables and the cable management system 10 of the present invention is operable to manage selected tasks concerning cables comprised in either small or large cable inventories.

The cable management system 10 is operable at its most basic level to gather information relating to a location of each of the cables 12A-D and to provide such gathered information in a selected report format. The reported cable location information may be simply archived for use or availability at a later time, may be displayed in a human-readable format for use by an operator, or may be transmitted upon request or automatically to another system operable to initiate prescribed actions in response to the received information. At more enhanced levels, the cable management system 10 is operable to not only gather and report location information with respect to the cables 12A-D but is operable as well to gather information on, or associate information about, predetermined characteristics of the cables 12A-D such as, for example, construction, capacity, length and grade of cable and connector type, and to report such cable characteristics information along with cable location information. In addition, the RF-ID tags attached to the articles may include other information such as unique identification information, such as serial numbers, GSI, parsing schemes, and ITIL. The cable information gathering, information associating, and location information reporting may be effected via any suitable approach. For the purposes of describing the operation of the cable management system of the present invention, the cable management system 10 in the following description is configured as a system using radio frequency identification technology (RF-ID).

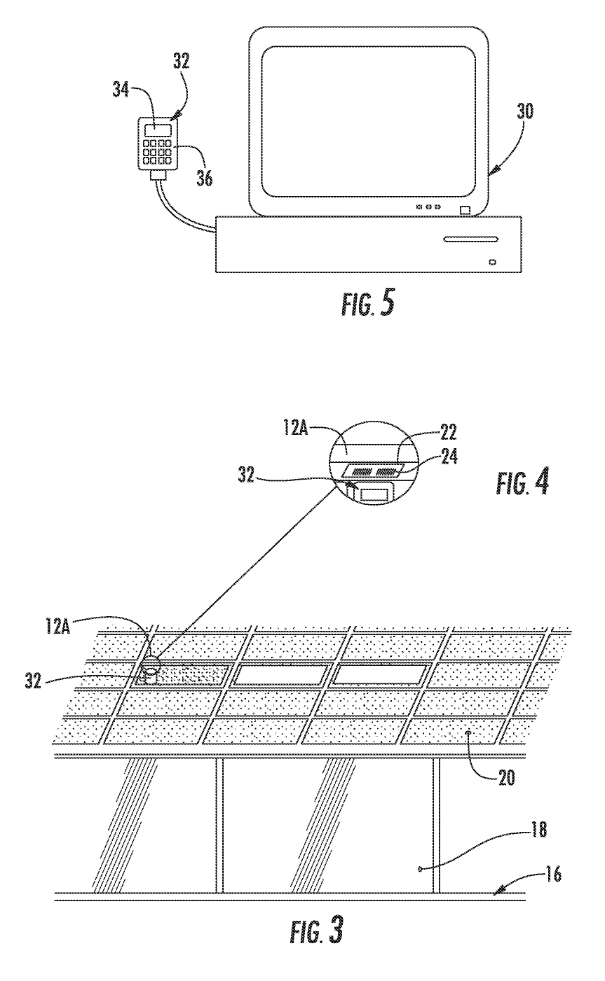

The cable management system 10 comprises a plurality of signal-transmitting devices each in the form of an RF-ID tag 22 and each tag 22 is operationally coupled to a respective one of the cables 12A-D in a manner to be described in more detail hereinafter. The quantity of tags 22 required for accomplishing the cable management tasks with respect to a given quantity of cables in a telecommunication system or computer system depends upon the particular cable location strategy that is to be carried out by the cable management system 10. As will be described herein, the tags 22 that are operationally associated with the cables 12A-D are denominated as tags 22-c1, 22-c2, 22-c3 . . . 22-cN. The RF-ID capability of each tag 22 permits each tag to be uniquely identified. Also, each tag is preferably provided with a feature that permits unique identification of the tag in addition to the unique identification provided by the RF-ID capability. Thus, as seen in FIG. 3, which is a perspective view of a portion of the ceiling 20 and of a wall 18 of the building 16 and FIG. 4, which is an enlarged perspective view of a tag 22 operationally coupled to the cable 12A, each tag 22 may have an unique indicia that is optically readable in the form of a bar code 24 affixed to the exterior of the tag 22.

The manner in which each tag 22 is operationally coupled to the respective associated cable 12A-D is as follows. For the purposes of illustration, it is assumed that the particular cable location strategy that is to be carried out by the cable management system 10 includes a rule or protocol according to which each cable having an end-to-end linear length of greater than an arbitrarily selected value—say, greater than six (6) feet—shall have a first tag 22 associated with one respective end of the cable and a second tag 22 associated with the other end of the cable. As seen in FIG. 1, the cable 12A, which is a cable deemed to have an end-to-end linear length of greater than six (6) feet—e.g., cable 12A has a length of nine (9) feet—has a tag 22-c1 associated with one end and a tag 22-c2 associated with its other end. The tag 22-c1 is affixed to the cable 12A in a manner in which the tag does not substantially detrimentally interfere with the transmission performance of the cable and, in this regard, the tag 22-c1 may be affixed to the cable 12A via adhesive, a removable fastener, heat shrink, or via a flexible loop band. The tag 22-c1 is affixed to the cable 12A at a location that is proximate to the one end of the cable yet at a spacing from the one end and this location is designated as the cable point surrogate location CE-1. There are a plurality of cable point surrogate locations CE-1, CE-2, CE-2 . . . CE-N corresponding in number to the number of tags 22-c1, 22-c2 . . . 22-cN. The tag 22-c2 is affixed to the cable 12A at a location that is proximate to the other end of the cable yet at a spacing from this other end and this location is designated as the cable point surrogate location CE-2. Depending upon the respective cable location strategy to be implemented by the cable management system 10, the location of each cable point surrogate location CE-1, CE-2, CE-2. CE-N relative to the surroundings of the structure in which the cables run can be evaluated by the cable management system 10 as a surrogate or proxy for the respective cable 12A-D itself. Thus, in connection with the interrogation of the pair of tags 22-c1, 22-c2 affixed to the cable 12A by the cable management system 10 in a manner to be described hereinafter, the cable management system 10 has the capability to “fix” or ascribe a location address to the cable 12A within the building 16 by using the evaluated locations of the pair of cable point surrogate location CE-1, CE-2 as the basis for ascribing this location address to the cable.

As further seen in FIG. 1, the cable 12B, which is a cable deemed to have an end-to-end linear length of less than six (6) feet—e.g., cable 12B has a length of four (4) feet—has only a single tag 22-c3 associated therewith, as it is assumed that another rule or protocol of the cable location strategy carried out by the cable management system 10 stipulates that cables having an end-to-end linear length of less than six (6) feet shall only have a single tag 22 associated therewith. The tag 22-c3 is affixed to the cable 12B at a location that is equidistant to the two ends of the cable and this location is designated as the cable point surrogate location CE-3. With further reference to FIG. 1, the cable 12C, which is a cable deemed to have an end-to-end linear length of greater than six (6) feet, has a tag 22-c4 associated with one end and a tag 22-c5 associated with its other end. The tag 22-c4 is affixed to the cable 12C at a location that is proximate to the end of the cable yet at a spacing from the end and this location is designated as the cable point surrogate location CE-4 and the tag 22-c5 is affixed to the cable 12C at a location that is proximate to the other end of the cable yet at a spacing from this other end and this location is designated as the cable point surrogate location CE-5.

With continuing reference to FIG. 1, the cable 12D, which is a cable deemed to have an end-to-end linear length of greater than six (6) feet, has a tag 22-c6 associated with one end and a tag 22-c7 associated with its other end. The tag 22-c6 is affixed to the cable 12D at a location that is proximate to the end of the cable yet at a spacing from the end and this location is designated as the cable point surrogate location CE-6. The other end of the cable 12D is secured in an equipment rack 26, the tag 22-c7 is affixed to the cable 12D at a location that is proximate to this other end of the cable yet at a spacing from this other end, and this location is designated as the cable point surrogate location CE-7. The equipment rack 26 has a landmark tag 28-AA secured to it and the landmark tag 28-AA is an RF-ID-capable tag having a data element describing the physical location of the equipment rack 26 within the building 16—e.g., the landmark tag 28-AA has a data element comprising data on the location of the equipment rack 26 in terms of an imaginary coordinate grid that has been overlaid on the building 16.

As seen in FIG. 5, a correlation and report sub-unit 30 of the cable management system 10 is schematically shown and this correlation and report sub-unit 30 is operable to receive information that has been obtained from the tags 22 and any landmark tags 28 such as the landmark tag 28-AA, to process this received information in accordance with predetermined processing routines such as, for example, a processing routine that correlates the unique identifying information of each tag with stored information concerning location way-stations throughout the building 16, and to generate reports for cable management purposes. Report sub-unit 30 includes a monitor so that this information may be displayed. Information may be obtained from the tags 22 and any landmark tags 28 via a hand held reader 32 and this hand held reader 32 is configured to generate a query signal that is detected, and responded to, by a tag 22 or a landmark tag 28. Hand reader 32 may be a Motorola MC-3090-G which is commercially available from Motorola. The hand held reader 32 extracts or reads the unique identifying information that is part of a signal received from a queried tag 22 or landmark tag 28 and stores this information in a memory function. The hand held reader 32 comprises a display 34 and a keypad 36 or other user input means such as a touch screen, scroll wheel or trackball (not shown), allowing an operator to enter information into the hand held reader 32 relating to the respective cable 12A-D whose associated tag 22 or tags 22 are currently being queried.

Referring now to FIG. 5, the correlation and report sub-unit 30 is a monitoring station and includes a microprocessor appliance such as a personal computer that stores and manipulates a cable management database for receiving information collected by the hand held reader 32. The cable management database preferably provides fields for many different types of information relating to the cables 12A-D, including but not limited to information on characteristics of each cable such as cable construction, capacity, and connector type. The information relating to each particular cable 12A-D is contained in a record in the cable management database referenced by the unique identifying information associated with the respective cable 12A-D by virtue of the associated tag 22. The personal computer of the correlation and report sub-unit 30 generates a report setting out information specific to cables 12A-D associated with the unique identifying information read by the hand held reader 32 and these reports may be custom tailored to the requirements of an operator using the cable management system implemented by the cable management system 10.

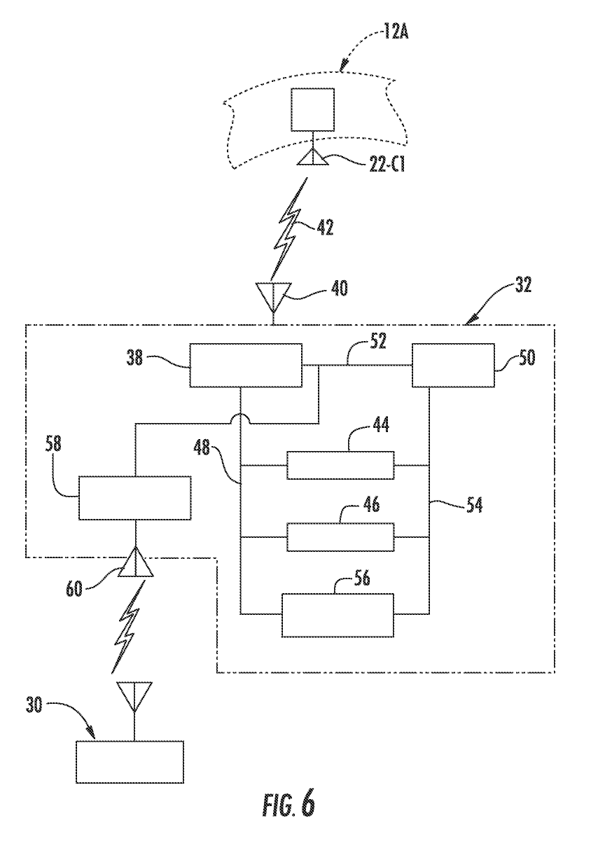

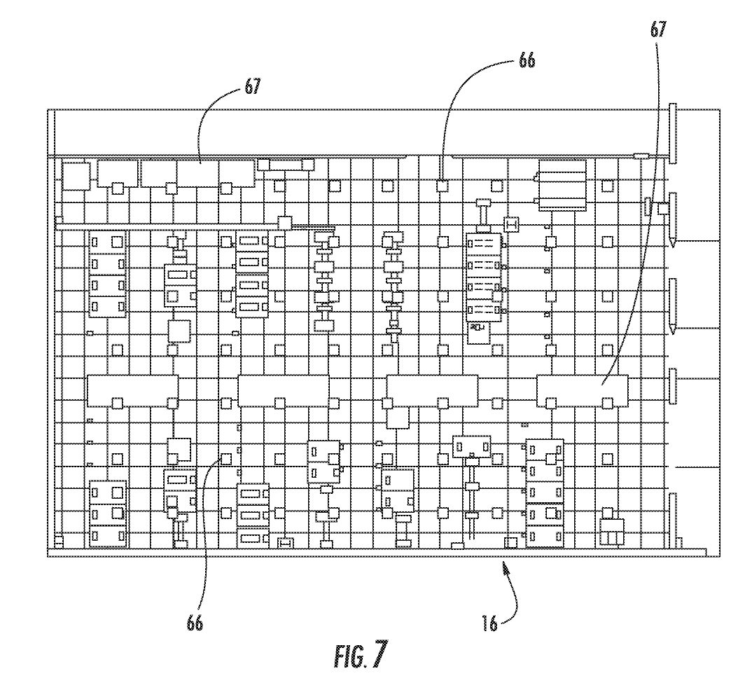

Each tag 22 and each landmark tag 28 is configured to transmit a radio frequency signal in response to a detected query, e.g., another radio frequency signal, from the hand held reader 32. As seen in FIG. 6, which is a schematic view of the hand held reader 32 and its operational relationship to the tags 22, the landmark tags 28, and the correlation and report sub-unit 30, it can be seen that the hand held reader 32 comprises an RF-ID interrogation transceiver 38 with an antenna 40 for sending and receiving signals 42 to and from the tags 22 and the landmark tags 28 such as, as exemplarily illustrated, signals sent to, and received, from the tag 22-c1 associated with the cable 12A. The hand held reader 32 also comprises a processor 44 and a memory function 46 which are coupled by a data bus 48 to each other and to the interrogation transceiver 38. A power supply 50 supplies power to these components via power leads 52, 54. The hand held reader 32 also includes a bar code reader 56 operable to read the bar codes 24 on the tags 22.

The hand held reader 32 operates as follows to obtain information from the tags 22 and the landmark tags 28. The interrogation transceiver 38 sends an interrogation signal 42 via the antenna 40 to one or more of the tags 22 that may be in the vicinity of the hand held reader 32 and the interrogation signal 20 is received by some or all of these tags 22. The tags 22 having received the interrogation signal 42 respond to the signal by providing their unique identifying information in a response signal that is received by the antenna 40. The interrogation transceiver 38 may be configured to vary the strength of its interrogation signal, adjust its receive sensitivity, and/or measure the relative signal strength of the responses received from the various tags 22 and this capability may be provided to the interrogation transceiver 38 in cooperation with the processor 44 and the memory function 46.

The hand held reader 32 also includes a system transceiver 58 for communicating via an antenna 60 with the correlation and report sub-unit 30 to which it may report or receive various data generated or used by the bar code reader 56 and/or by the processor 44. The hand held reader 32 can also be linked to the correlation and report sub-unit 30 via a transfer cable 62, as shown in FIG. 5.

It can thus be understood that the cable management system 10 provides a system for managing selected tasks with respect to the cables of, for example, a telecommunication system or a computer that offers the flexibility to forego a visual inspection and confirmation of the locations of the cables within a structure. Instead, via deployment of the cable management system 10, it is possible to obtain a “real time” or current status of the locations of the cables within a structure without the necessity of removing covering structures such as access panels, ceiling panels, or the like. For example, as seen in FIGS. 3 and 4, the hand held reader 32 can interrogate the tags 22-c1 and 22-c2 affixed to the cable 12A even though the cable 12A is situated between a ceiling panel and a higher structure such as a roof and the cable 12A cannot be visually inspected from the interior of the building 16 without removal of a ceiling tile.

The cable management system 10 therefore advantageously exploits the wireless signal transmission capability available between the tags 22 and the hand held reader 32 to provide a convenient framework for an operator to easily and rapidly perform a “real time” or current update of the status of the locations of the cables 12A-D within the building 16. With respect to the assignment of locational information to the cables identified by the hand held reader 32 during such a cable inventory process, there are a number of approaches that can be readily implemented by the cable management system 10. For example, each of the landmark tags such as the landmark tag 28-AA can be located in a permanent location at selected venues within the building 16 such as, for example, a permanent mounting of the landmark tag 28-AA at the venue of the equipment rack 26. The hand held reader 32 can be configured, in coordination with the correlation and report sub-unit 30, to transmit query signals operable to elicit response signals from the landmark tags 28 and can perform, for example, a judgment protocol based upon the strength of the various responses signals received from the adjacent landmark tags 28 to assign a locational tag along with information received by the hand held reader 32 about the respective cables 12A-D that have been identified within the vicinity of the hand held reader. The concept of assigning a location should be understood as being a flexible concept in that it may be sufficient for a given cable location inventory to merely determine that, with respect to, say, four quadrants of the interior of the building 16, the respective cables 12A-D within each quadrant have been identified and inventoried. In other circumstances, the cable management system 10 may be configured to ascertain and log locational information for more limited regions within the building 16 such as, for example, the more limited regions delimited by the respective equipment racks within each quadrant of the building 16.

The benefits of the cable management system 10 can be seen with regard to an example of two cable location inventories that are performed with the variable that the location of one end of a cable has changed in the time interval between the first cable location and the second cable location inventory. Thus, if a first cable location inventory is performed to ascertain and log the locations of the cables 12A-D within the building 16 shown in FIG. 1, and if a second cable location is performed to ascertain and log the locations of the cables 12A-D within the building 16 shown in FIG. 2, it can be seen that one end of the cable 12D has, in the time interval between the first cable location and the second cable location inventory, been disconnected from the equipment rack 26 and has been connected to another equipment rack 62. Accordingly, during the first cable location inventory to ascertain and log the locations of the cables 12A-D within the building 16 shown in FIG. 1, the hand held reader 32 interrogates the tag 22-c7, the tag 22-c7 responds with identifying information, and the hand held reader 32, in coordination with the correlation and report sub-unit 30, determines that the locational tag to be associated with the information received from the tag 22-c7 identifying the one end of the cable 12D will be the location information furnished to the hand held reader 32 by the landmark tag 28-AA coupled to the equipment rack 26 to which the cable 12D is connected. Thereafter, during the second cable location inventory to ascertain and log the locations of the cables 12A-D within the building 16 shown in FIG. 2, the hand held reader 32 interrogates the tag 22-c7, the tag 22-c7 responds with identifying information, and the hand held reader 32, in coordination with the correlation and report sub-unit 30, determines that the locational tag to be associated with the information received from the tag 22-c7 identifying the one end of the cable 12D will be the location information furnished to the hand held reader 32 by a landmark tag 28-BB coupled to the other equipment rack 62 to which the cable 12D has freshly been connected.

It is also contemplated that the cable management system 10 can include suitable enhancements to facilitate the information gathering, information associating, and information archiving tasks to be performed in a cable location inventory. For example, the hand held reader 32, in coordination with the correlation and report sub-unit 30, can be configured to display a list of the total inventory of cables and can include an input function for an operator to select a given cable from the list via, for example, a “find” input function. Thereafter, as the operator moves about the building 16 while carrying the hand held reader 32, the hand held reader will alert the operator via, for example, a “beep” tone, that the hand held reader is within interrogation range of the selected given cable. As another example, the hand held reader 32, in coordination with the correlation and report sub-unit 30, can be configured to display a list of cables that have been identified during the current move about session and can include an input function for an operator to select a given identified cable from the list and to request the hand held reader 32 to search for the other not-yet identified end of the selected given cable. Thereafter, as the operator moves about the building 16 while carrying the hand held reader 32, the hand held reader will alert the operator via, for example, a “beep” tone, that the hand held reader is within interrogation range of this other end of the selected given cable.

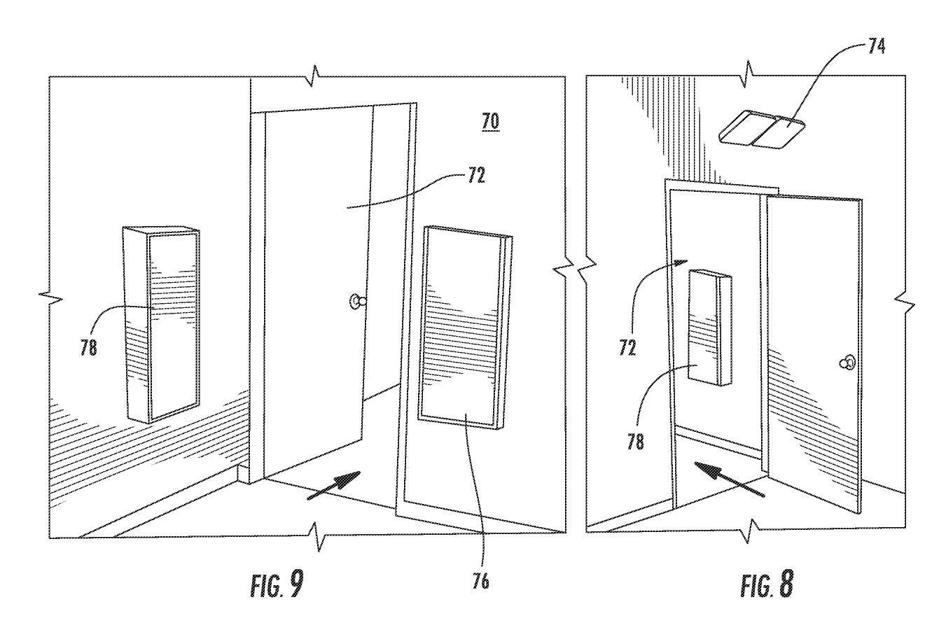

In another embodiment, as illustrated in FIG. 7, there is a provided building 16 having a plurality of RF-ID readers 66 attached to the ceiling 20 of the building forming a grid of RF-ID readers. Readers 66 are commercially available from AWID as Part No. MPR-2010-BN-ENI-0. Antennas without readers are commercially available from AWID as Part No. MPR-2012-ANT-B-0. In the embodiment of FIG. 7, there are seventy readers 66 substantially equally spaced apart from one another, forming Y axis columns and X axis rows. Each reader is enabled to decipher RF-ID tags attached to articles, such as cable, within building 16. The readers 66 are connected to report sub-unit 30, which includes a monitor, shown in FIG. 5, by a communication channel, such as a hard wired connection or a wireless connection. As an article having an RF-ID tag moves through building 16, each reader 66 in the grid will communicate with the RF-ID tag on that particular article and transmit that location information to report sub-unit 30 and then to the monitor. Thus, the movement and position of the article through building 16 may be determined instantaneously.

Room 68 also includes a plurality of cabinets 67 which are adapted to house electronic equipment, such as servers, patch panels and the like. In one embodiment, the readers 66 which form the grid are attached to the tops of the cabinets 67 rather than the ceiling. Alternatively, some of the readers 66 may be placed on the ceiling while others may be placed on the top of the cabinets 67. In addition, RF-ID tags may be placed on cabinets 67. An RF-ID tag on a cabinet may contain information which associates equipment in the cabinet, such as a patch panel, with articles such as cables connected to the patch panel.

Preferably, each RF-ID tag has a label attached thereto. The label may include a bar code containing information about the article so that the user may seamlessly move between an RF-ID mode and a bar code mode. Obviously, the user will need to use a bar code reader to read information from the bar code. The bar code may contain all or some of the information which is contained on the RF-ID tags. The addition, the label may include text printed thereon containing information about the article.

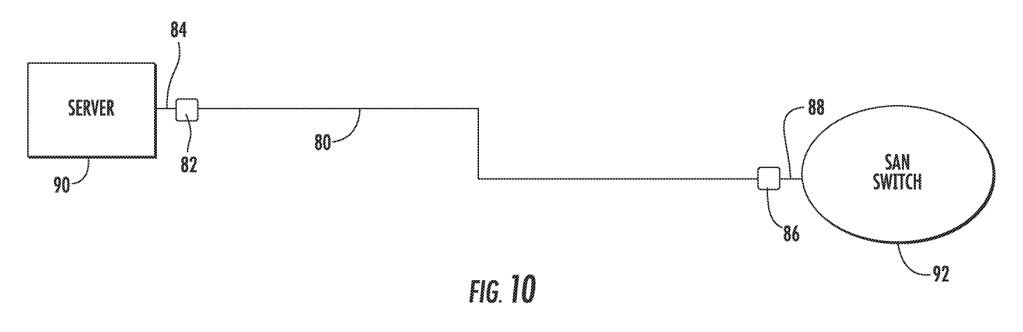

Referring now more particularly to FIGS. 8 and 9, building 16 is divided into a plurality of rooms, such as room 68 and room 70. Room 68 and room 70 are connected together by portal 72 which in this embodiment is a door opening. In the embodiment of FIG. 8, data acquisition station 74 is mounted over portal 72. The data acquisition station 74 may include a section having an RF-ID reader and a section having an antenna. Thus, when an article, such as a length of cable having an RF-ID tag, passes through portal 72, the RF-ID reader in data acquisition station 74 will sense the presence of the RF-ID tag and determine that the article is passing through the portal. Other devices may also be included in data acquisition station 74, such as a camera and a motion sensor which may be infrared or photo-electric. However preferably, the overhead data acquisition station 74 at least includes an RF-ID reader. The camera and motion sensor can be set so that the camera will take a picture of the article moving through portal 72 only when the RF-ID reader in the data acquisition station 74 fails to detect an RF-ID tag attached to the article, i.e., the RF-ID tag has been removed from the article.

The embodiment of FIG. 9 includes data acquisition station 76 mounted on one side of portal 72 and data acquisition station 78 mounted on the other side of portal 72. Data acquisition stations 76 and 78 may each include RF-ID readers as well as cameras and motion sensors. If someone has removed the RF-ID tag or tags from the article, these other detection devices may be used to detect the movement of the article through the portal. In addition, a picture may be taken of the article moving through the portal.

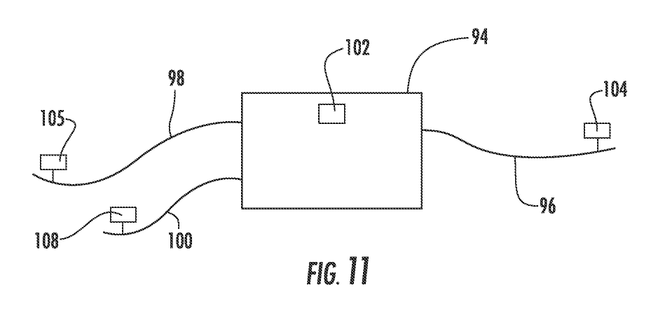

Referring now more particularly to FIG. 10, there is provided cable 80, which may be an optical fiber cable or an electrical cable. A first RF-ID tag 82 is connected proximate end 84 of cable 80. A second RF-ID tag 86 is connected proximate end 88 of cable 80. In this embodiment, end 84 of cable 80 is connected to server 90 while end 88 of cable 80 is connected to switch 92. In addition to normal information about cable 80, RF-ID tag 82 contains information about the location of end 88 of cable 80 and RF-ID tag 86 also contains information about the location of end 84 of cable 80. If a user senses RF-ID tag 82 by a reader, such as hand reader 32, the user will also know the location of end 88 of cable 80. The user may then scan RF-ID tag 86 to verify the location of the end 88 of cable 80. Likewise, when a user with a handheld reader senses RF-ID tag 86, he will also know the location of end 84 of cable 80. This location information is normally inputted to a RF-ID tag at the time that the cable is installed.

Referring now more particularly to FIG. 11, an interconnection apparatus 94, such as a patch panel, is provided. A plurality of devices, such as cables 96, 98 and 100, are connected to patch panel 94. A parent RF-ID tag 102 is connected to patch panel 94. A child RF-ID tag 104 is attached to cable 96, a child RF-ID tag 106 is attached to cable 98, and a child RF-ID tag 108 is attached to cable 100. Parent RF-ID tag 102 contains at least some information about cables 96, 98 and 100 which information is also contained in RF-ID tags 104, 106 and 108. Thus, by placing the reader near parent RF-ID tag 102, the user can determine certain information about cables 96, 98 and 100 which are attached to the patch panel 94.

While embodiments of the invention have been described and illustrated herein, it is to be distinctly understood that the invention is not limited thereto, but may be otherwise variously embodied and practiced within the scope of the following claims.

1. A system for monitoring the position and movement of articles within a building comprising:
a plurality of articles;
at least one radio frequency identification (“RF-ID”) tag associated with each article; the RF-ID tag associated with a particular article containing information which distinguishes that particular article from the articles;
the building receiving at least some of the articles;
a plurality of readers located within the building; the readers enabled to decipher information from the RF-ID tags; the readers being spaced apart from one another forming a grid;
a monitoring station; the readers connected to the monitoring station by a communications channel whereby the position and movement of articles within the building may be determined.

2. A system as set forth in claim 1 wherein the system is able to store data relating to the deciphered information.

3. A system as set forth in claim 1 wherein the system also monitors the relationships and attributes of the articles.

4. A system as forth in claim 1, further including a plurality of cabinets received within the building; the cabinets housing equipment; at least some of the cabinets having an RF-ID tag; at least some of the articles attached to the equipment, whereby an RF-ID tag associated with a cabinet contains information regarding the equipment and the articles attached to the equipment.

5. A system as set for in claim 1 wherein the building has a ceiling; at least some of the readers attached to the ceiling.

6. A system as set forth in claim 1 wherein the readers are located on an X axis and a Y axis.

7. A system as set forth in claim 1 wherein readers are substantially evenly spaced apart from one another.

8. A system as set forth in claim 1, further including a plurality of cabinets received within the building; at least some of the readers received by the cabinets.

9. A system as set forth in claim 1 wherein the readers are hard wired to the monitoring station.

10. A system as set forth in claim 1 wherein the readers are wirelessly connected to the monitoring station.

11. A system as set forth in claim 1 wherein the spacing of the readers on the reader grid is between ten feet and fifteen fee.

12. A system as set forth in claim 1 wherein the articles are telecommunication apparatuses.

13. A system as set forth in claim 12 wherein the telecommunication apparatuses are cables.

14. A system as set forth in claim 1 wherein each RF-ID tag is attached to a label; the label includes a bar code containing information about the article.

15. A system as set forth in claim 14 wherein each label further includes text containing information about the article.

16. A system for monitoring the position and movement of articles within a building comprising:
a plurality of articles;
at least one radio frequency identification (“RF-ID”) tag associated with each article; the RF-ID tag associated with a particular article containing information which distinguishes that particular article from the other articles;
the building receiving at least some of the articles; the building having at least two rooms;
a portal located between the two rooms;
a data acquisition station associated with the portal; the data acquisition station including a reader;
the reader enabled to decipher information from the RF-ID tags;
a monitoring station; the reader connected to the monitoring station by a communications channel whereby the movement of articles through the portal may be determined.

17. A system as set forth in claim 16 wherein the data acquisition station is located above the portal.

18. A system as set forth in claim 16 wherein the data acquisition station is located to the side of the portal.

19. A system as set forth in claim 18 wherein the data acquisition station includes a motion sensor.

20. A system as set forth in claim 19 wherein the data acquisition station includes a camera; the camera is enabled by the motion detector only if the RF-ID tag on an article is not sensed by the reader when motion is detected.

21. A system as set forth in claim 16 wherein the data acquisition station includes at least first and second substations; the first substation being located above the portal; the second substation being located to one side of the portal.

22. A system as set forth in claim 16 wherein the articles are telecommunications apparatuses.

23. A system as set forth in claim 22 wherein the telecommunications apparatuses are cables.

24. A method for determining the location of one end of an installed cable comprising:
providing an elongated cable having first and second ends;
applying a first radio frequency identification (“RF-ID”) tag proximate the first end;
applying a second RF-ID tag proximate the second end;
installing the cable wherein the first end is at a first location and the second end is at a second location;
inputting information in the first RF-ID tag, including information containing the fact that the second end of the cable is located at the second location;
providing a reader which is enabled to decipher information from the first and second RF-ID tags whereby the location of the second end of the cable may be determined by the reader receiving information from the first RF-ID tag.

25. A system for obtaining information about devices attached to an interconnection apparatus comprising:
an interconnection apparatus;
a plurality of devices connected to the interconnection apparatus;
a child radio frequency identification (“RF-ID”) tag connected to each device; each child RF-ID tag containing information about the device it is connected to;
a parent RF-ID tag attached to the interconnection apparatus;
a reader enabled to decipher information from the parent RF-ID tag and each child RF-ID tag; the parent RF-ID tag containing at least some information which is contained in each child RF-ID tag whereby certain information about each device may be obtained by using the reader to access information from the parent RF-ID tag.
